(19) United States
(12) Patent Application Publication
(10) Pub. No.: US 2025/0151155 A1
(43) Pub. Date: May 8, 2025

(54) METHODS AND DEVICES FOR ADAPTING CONFIGURATION OF DISCONTINUOUS RECEPTION FOR USER EQUIPMENT

(71) Applicant: Sony Group Corporation, Tokyo (JP)

(72) Inventors: Nafiseh Seyed MAZLOUM, Lund (SE); Anders BERGGREN, Lund (SE); Basuki PRIYANTO, Lund (SE); Torgny PALENIUS, Barsebäck (SE)

(21) Appl. No.: 18/837,021

(22) PCT Filed: Jan. 11, 2023
(86) PCT No.: PCT/EP2023/050574

§ 371 Date: Aug. 8, 2024

(30) Foreign Application Priority Data
Feb. 25, 2022 (SE) 2250267-8

(51) Int. Cl. H04W 76/28; H04W 52/02; H04W 56/00

(52) U.S. Cl. CPC H04W 76/28; H04W 52/0216; H04W 56/0045

(57) ABSTRACT

Method carried out in an access node (121) of a wireless network (100) for managing configuration of discontinuous reception, DRX, for a user equipment, UE (10), said DRX configuration comprising ON durations repeated with a DRX cycle, wherein the method comprises: obtaining (520) adjusted timing for a next ON duration, based on traffic information of data for the UE; transmitting (540), to the UE, information (PAR) identifying the adjusted timing; and transmitting (550) the data to the UE in the next ON duration according to the adjusted timing.

### TECHNICAL FIELD

This disclosure is related to wireless communication between a wireless device and a wireless network. Specifically, solutions are provided for adapting configurations for discontinuous reception in the wireless device.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

Every UE needs to be powered in some way to be able to communicate with the wireless network. Regardless of the capability of the UE, energy conservation is a relevant factor to consider because it will affect the user experience. High energy consumption reduces UE battery life. This may reduce user experience. Discontinuous reception is one of the known techniques to minimize UE energy consumption. In various types of 3GPP radio access technologies, procedures for connected mode discontinuous reception (DRX) have been implemented, which inter alia has the benefit of reducing energy consumption in the UE. DRX may be configured for idle mode or connected mode operation.

In plain terms, when the UE is configured with connected mode DRX, or C-DRX, the UE follows a configured DRX cycle comprising a period of inactivity at which the UE powers down most of its circuitry. This period may be referred to as an Off Duration. With a periodicity defined by the DRX cycle, the UE powers up and holds its radio receiver active for a duration referred to as an On Duration. If an indication is received that data is transmitted in the DL in the On Duration period, a configured DRX inactivity timer may prolong the time the radio receiver is active, thus reducing the actual off period of the subsequent Off duration.

DRX configuration has thus been implemented for data traffic with expected longer periods of inactivity. A further legacy development is the use of so-called short DRX cycles, as opposed to a general long DRX cycle, and implies that the UE is configured with shorter intervals of inactivity between the On Durations. This may be triggered by UE reception of DL data in an On Duration of a long DRX cycle. The UE then applies a shorter DRX cycle, known as Short DRX Cycle duration, for a certain pendency, which may be determined by a timer. The UE is thus able to receive data more frequently for that pendency. The duration of the long DRX Cycle duration is in this context an integer multiple of the short DRX Cycle duration.

Legacy DRX configuration has thus improved the possibility for UE to conserve energy, while at the same time allowed for the network to conveniently use its radio resources for other purposes, when e.g. scarce DL traffic is transmitted. However, current DRX configurations are inflexible, and are not suited for many evolving application types.

### SUMMARY

In view of the foregoing, it is an objective to present a solution for adapting DRX configuration for UEs connected to a wireless network, which serve to reduce energy consumption in the UE. An aspect of this objective is to provide a more flexible solution for configuring UEs with regard to DRX configuration based on traffic information associated with data intended for the UE.

The proposed solution, which targets these objectives, is set out in the independent claims, whereas various examples thereof are set out in the dependent claims and in the following detailed description.

According to a first aspect, a method is provided which is carried out in an access node of a wireless network for managing configuration of discontinuous reception, DRX, for a user equipment, UE, said DRX configuration comprising ON durations repeated with a DRX cycle, wherein the method comprises:
obtaining adjusted timing for the ON durations based on traffic information of data for the UE;
transmitting the data to the UE according to the adjusted timing, said UE being configured according to the adjusted timing.

An access node of the wireless network comprises:
a transceiver for wireless communication with a user equipment, UE; and
logic circuitry configured to control the access node to carry out the method of the proposed solution for managing discontinuous reception, DRX, configuration for the UE.

According to a second aspect, a method is provided which is carried out in a user equipment, UE, for managing discontinuous reception, DRX, configuration, said DRX configuration comprising ON durations repeated with a DRX cycle, wherein the method comprises:
obtaining adjusted timing for the ON durations based on traffic information of data for the UE;
receiving the data from an access node of a wireless network, said access node being configured to transmit the data according to the adjusted timing.

A user equipment, UE, comprises:
a transceiver for wireless communication with a wireless network; and
logic circuitry configured to control the UE to carry out the method of the proposed solution for managing discontinuous reception, DRX, configuration.

Based on the proposed solution, a mechanism is obtained for adapting a DRX configuration such that misalignment of data packet arrival time and the DRX ON durations may be taken care of in an efficient way. This may inter alia result reduced energy consumption in the UE.

### BRIEF DESCRIPTION THE DRAWINGS

FIG. 1 schematically illustrates an implementation of a wireless communication system, in which a UE communicates with a wireless network by radio communication.

FIG. 2 schematically illustrates a UE configured to operate with the wireless network according to various examples.

FIG. 3 schematically illustrates an access node configured to operate in the wireless network for communication with the UE according to various examples.

FIG. 4 generally illustrates DRX operation and its correlation with expected packet arrival of data traffic intended for the UE.

FIG. 5 is a flowchart illustrating various steps carried out by the access node according to an embodiment of the proposed solution.

FIG. 6 is a flowchart illustrating various steps carried out by the UE according to an embodiment of the proposed solution.

FIG. 7 illustrates determination of mismatch between DRX ON duration and expected packet arrival, useful in various embodiments of the proposed solution.

FIG. 8 illustrates an example of a scheme flowchart for identifying or determining timing adjustment of an ON duration according to some embodiments.

FIGS. 9A and 9B show examples of timing adjustment using the process of the scheme of FIG. 8, for different DRX configurations.

FIG. 10 illustrates an example of an extended scheme flowchart, compared to FIG. 8, for identifying or determining timing adjustment of an ON duration according to some embodiments, which includes the option of extension of the ON duration active period.

FIG. 11 is an example of timing adjustment using the process of the scheme outlined in FIG. 8.

FIG. 12 shows a signaling diagram, identifying various aspects of the proposed solution when operating according to an implicit approach.

FIG. 13 shows a signaling diagram, identifying various aspects of the proposed solution when operating according to a first explicit approach where the access node controls the timing adjustment in the UE.

FIGS. 14A and 14B show examples of timing adjustment using a second explicit approach, where the access node controls the timing adjustment in the UE with an early indication signal.

FIGS. 15A and 15B show examples of timing adjustment using the process of the scheme of FIG. 8 for different DRX configurations, and conveying the timing adjustment in the early indication signal.

FIG. 16 shows a signaling diagram, identifying various aspects of the proposed solution when operating according to the explicit approach where the access node controls the timing adjustment in the UE by means of the early indication signal.

### DETAILED DESCRIPTION

In the following description, for the purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

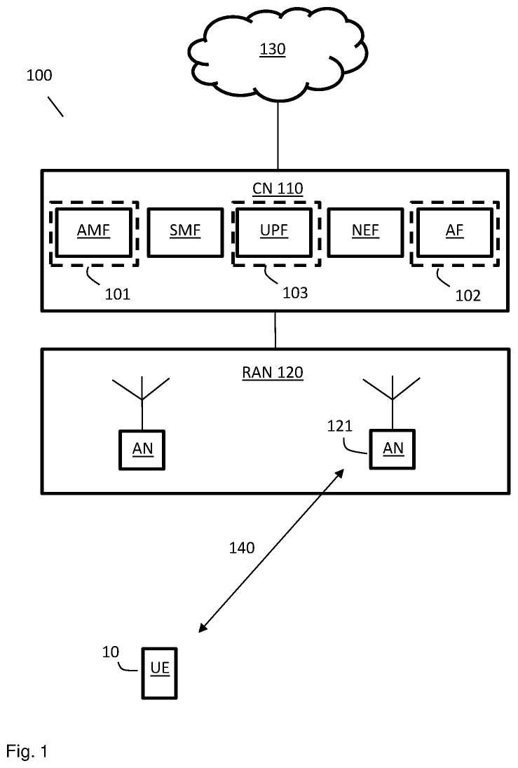

FIG. 1 illustrates a high-level perspective of operation of a UE 10 in a wireless system, configured to communicate with a wireless communication network 100, denoted wireless network 100 for short herein. The wireless network 100 may be a radio communication network 100, configured to operate under the provisions of 5G as specified by 3GPP, according to various examples, or further generations. The wireless network 100 may comprise a core network (CN) 110, connectable to an external network 130 such as the Internet. The core network may comprise a plurality of core network nodes, which realize logical functions. For the example of a 5G system, as illustrated, this may inter alia include the Access and Mobility Management Function (AMF) 101, a Session Management Function (SMF), a User Plane Function (UPF) 103, a Network Exposure Function (NEF), and an Application Function (AF) 102, all of which are legacy functions of the 5G system. The AF(s) may also be deployed outside of the 5G system i.e. as an application running on an application server connected to the external network e.g. the Internet.

The core network 110 is connected to at least one access network 120, also referred to as a Radio Access Network (RAN), comprising one or more base stations or access nodes, of which one access nodes 121 is illustrated. The access node 121 is a radio node configured for wireless communication on a physical channel 140 with various UEs. The physical channel 140 may be used for setting up one or more logical channels between UEs and the wireless network, such as with the AMF.

Before discussing further details and aspects of the proposed method, functional elements for examples of the entities involved in carrying out the proposed solution will be briefly discussed, including the access node 121 and the UE 10.

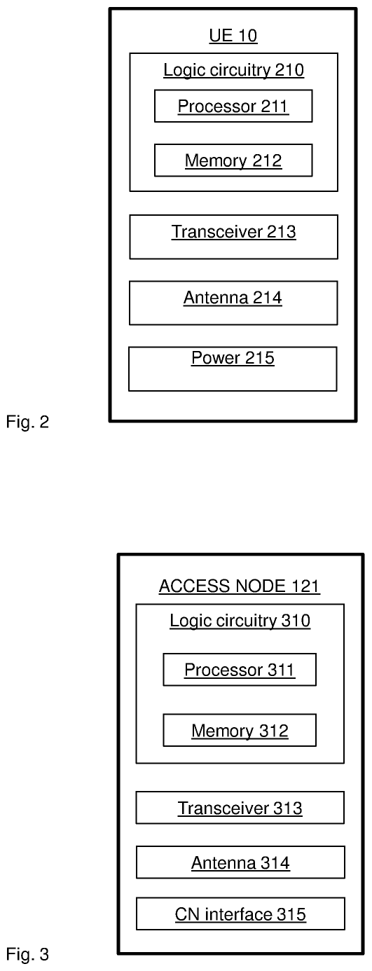

FIG. 2 schematically illustrates an example of the UE 10 for use in a wireless network 100 as presented herein, and for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213 for communicating with other entities of the radio communication network 100, such as the access node 121, in one or more frequency bands. The transceiver 213 may thus include a receiver chain (Rx) and a transmitter chain (Tx), for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic gain to transmit radio signals. In other examples, the antenna system 214 may comprise a plurality of antennas for operation of different beams in transmission and/or reception. The antenna system 214 may comprise different antenna ports, to which the Rx and the Tx, respectively, may selectively be connected. For this purpose, the antenna system 214 may comprise an antenna switch.

The UE 10 further comprises logic circuitry 210 configured to communicate data and control signals, via the radio transceiver, on a physical channel 140 to a serving access node 121 of the wireless network 100. The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 (e.g., a battery) that provides energy to the other components of the UE 10.

FIG. 3 schematically illustrates a radio node in the form of an access node 121 of the wireless network 100 as presented herein, and for carrying out the method steps as outlined. An access node 121 may have one or more transmission and reception point(s) TRP(s). In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 121 further comprises logic circuitry 310 configured to control the access node 121 to communicate with the UE 10 via the radio transceiver 313 on the physical channel 140.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node 121 may further comprise, or be connected to, an antenna 314, which may include an antenna array. The logic 310 may further be configured to control the radio transceiver to employ an isotropic sensitivity profile of the antenna array to transmit radio signals in a particular transmit direction. The access node 121 may further comprise an interface 315, configured for communication with the core network 110. Obviously, the access node 121 may include other features and elements than those shown in the drawing or described herein, such as a power supply and a casing etc.

Throughout the years, the use of UEs in wireless networks has developed considerably. From originally being designed for voice communication, the wireless networks, and the technical specifications associated to operation and configuration of such networks, are predominantly used for data communication. Moreover, different use cases and applications continuously develop, and different UE types are implemented, particularly UE type for a specific use-case, such as non-user handled devices commonly referred to as Internet of Things (IoT) devices of comparatively low-complexity. Different so-called verticals have been defined, to identified different types of context and use cases.

Supporting Extended Reality (XR) is one of those verticals. The term Extended Reality (XR) is used to identify real-and-virtual combined environments and human-machine interactions, and covers different types of several applications, such as Virtual Reality (VR), Augmented Reality (AR), and Cloud Gaming (CG). The main characteristics are the requirements on relatively high data rate and low latency. 5G NR (New Radio) was introduced to support eMBB (high data rate), URLLC (low latency), and mMTC (high number of devices). Hence, 5G NR was not designed to support the combination of the aforementioned requirements which is suitable for XR applications. Specifically, DRX operation is for various reasons not suitably designed for XR applications.

Radio resource allocation is one important area for handling XR traffic type and meeting Key Performance Indication (KPI) in both downlink and uplink transmission. UE energy efficiency, capacity, and latency are identified as selected KPIs for XR traffic. XR video traffic is similar to MBB services in the sense that its Application Data Unit (ADU) size varies just as FTP or web browsing. On the other hand, packet arrival time or periodicity of the traffic generation is more predictable than the MBB services. For example, XR traffic may have a quasi-static periodicity. This is since video has a fixed frame refresh rate. However, XR put higher requirements on latency, and it requires reasonably high reliability.

For predictable arrival times, DL and UL configured grants, i.e., Semi-Persistent Scheduling (SPS) and Configured Grant (CG), respectively, have been specified, but these mechanisms may not be suitable for handling large and varying video frame sizes, due to their fixed and reduced resource allocation. A further challenge for their applicability is handling impact from jitter. Also, the existing configuration for setting up CG periodicity may not match well with pose/control and video traffic periodicities, which for example can be equal to 4 msec and 16.67 msec, assuming 60 video frames per second (fps), respectively.

Another important aspect is energy efficiency. Low power consumption is important for devices such as smartphones, smart glasses, and tablet used for XR applications. Discontinuous reception (DRX), where the UE switches its receiver off and on periodically, is typically used to reduce device power consumption. Existing DRX configurations are, however, not optimized for XR type traffics. In the other words, XR may not be optimally operated in 5G NR network, such as unable reaching the required data rate/latency and it also has high UE power consumption, hence, reducing user experience.

Certain types of data traffic, such as XR traffic, is thus characterized by periodic arrival time of data packets. In order to save UE energy consumption, ideally, the UE should be configured with the DRX configuration in which the DRX ON duration is aligned with the packet arrival timing and rate from the application/network. In reality, in the RAN domain, the DRX configuration may not be aligned with the packet arrival time, due to the non-integer arrival rate. Additionally, there may be jitter as well, affecting the packet arrival time. These two are described as follows:

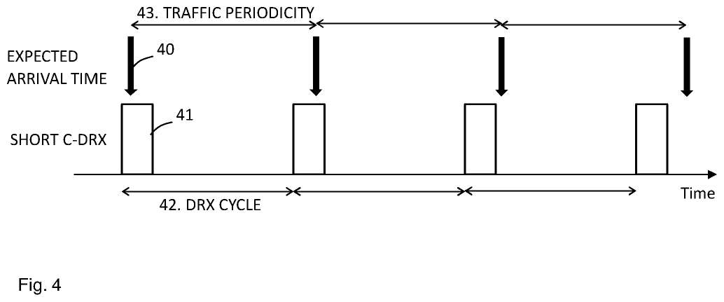

FIG. 4 is provided to schematically illustrate a problem associated with data communication for certain applications, such as certain XR applications. The application may contain and generate data traffic at a rate that is not aligned with any integer DRX periodicity in the order of milliseconds. This causes misalignment of packet arrival 40, resulting in downlink packets arriving prior to or after the scheduled DRX ON duration 41. In the example shown in FIG. 4, the data traffic has packet frame arrival of 60 fps (frames per second) which gives a non-integer periodicity of packet arrival rate, or traffic periodicity 43, of 16.67 ms. Connected mode DRX (C-DRX) cycle 42 values support only integer multiples of 1 ms, and is here configured to 16 ms. As can be seen, a DRX ON duration 41 cannot consistently be exactly aligned with DL frame arrival timing 40. This would mean that the packets would arrive further and further outside the DRX active window or ON duration 41 after the first two transmission, here assuming we have a 1 ms DRX ON duration window. Clearly, had a DRX cycle 42 of 17 ms been applied, the packets would eventually arrive in advance of the intended configured DRX ON duration 41.

Another problem related to various types of deterministic data traffic, such as XR traffic, and packet arrival rate is the impact from potential jitter that comes from generating and transmitting e.g. video frames. These types of traffic might not be perfectly periodic which can be characterized as jitter. Jitter basically means the arrival of frames within a certain range becomes less predictable. This makes the arrival rate not fully deterministic, and some flexibility may thus be needed to monitor a DL channel. With a short period for the DRX ON duration, the packet may arrive before the ON duration, but also after the ON duration which subsequently increases delay, since the packet cannot be received until the subsequent ON duration. A long DRX ON duration can be applied to avoid delay, with the drawback being increased energy consumption in the UE 10.

Various solutions are provided herein, aiming at overcoming the mentioned problems and shortcomings of the state of the art. In some respects this includes handling timing misalignment of the packet arrival, resulting from non-integer characteristics of packet arrival rate and jitter, with respect to DRX cycles. The proposed solution provides for adaptation of a DRX configuration to minimize UE energy consumption and ensuring proper reception of data packets at the UE side. In some examples, the solution utilizes traffic aware techniques, or traffic aware information, in adapting the DRX configuration to XR type service and applications.

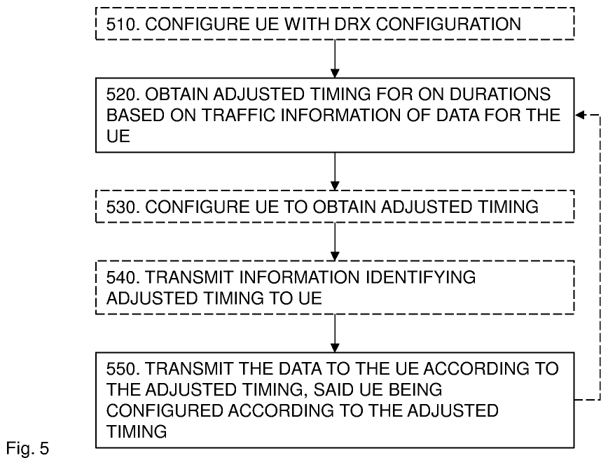

FIG. 5 shows a flowchart of a general presentation of a method carried out in the access node 121 of a wireless network 100, according to the proposed solution.

In optional step 510 the access node 121 configures the UE 10 with a DRX configuration.

Configuring the UE 10 may be carried out by transmitting radio resource control (RRC) signaling, e.g. according to legacy procedures. As an alternative, the UE 10 may be pre-configured with the DRX configuration, by specified default, or arranged to determine the DRX configuration or based on other input, such as based on characteristics of data to be received, e.g. identified by application type. The DRX configuration comprises timing data and radio parameters for identifying ON durations repeated with a DRX cycle. In some embodiments, the DRX configuration may comprise multiple DRX configurations, with respective ON durations repeated with DRX cycles which may be different. The DRX configuration may be a connected mode DRX configuration (C-DRX), e.g. as short C-DRX according to legacy 3GPP specifications.

In step 520, the access node 121 obtains adjusted timing for the ON durations based on traffic information of data for the UE.

In optional step 530, which may form part of certain embodiments, the access node 121 configures the UE 10 to obtain adjusted timing for adaptation of ON durations of the DRX configuration. This step may include the access node 121 transmitting information which identifies a scheme for determining the adjusted timing in the UE 10. This information may in some embodiments comprise traffic information associated with the data traffic intended for the UE 10 using the DRX configuration. Additionally, or alternatively, the information may identify an algorithm usable by the UE for timing adjustment of ON durations of the DRX configuration. The UE 10 is thus configured to subsequently determine timing adjustment of each ON duration based on the received information.

This step may be carried out by the access node 121 by determining the adjusted timing based on the traffic information. Alternatively, the determination of the adjusted timing may have been determined by another entity, such as a core network node or application function, or by assistance data from the UE, e.g. if an application session is initiated in the UE 10, wherein the access node 121 receives the determined adjusted timing. The traffic information may provide identification of an application or service type for which the data traffic is to be communicated. Alternatively, the traffic information provides information of one or more data flows, in which the data traffic will be communicated. The traffic information may inter alia identify a periodicity, i.e. packet arrival rate, of the data traffic, for one or more flows where applicable. In some examples, the traffic information may identify jitter associated with the data traffic, which may be measured by a node of the wireless network or conveyed as an estimate associated with the data traffic. The adjusted timing may refer to a specific ON duration, or a scheme for successively adjusting the ON durations according to a predetermined rule.

In step 540, which included in some embodiments, the access node 121 transmits information identifying the adjusted timing to the UE 10. In various embodiments the information identifying the adjusted timing is transmitted in one ON duration for application in at least a next, upcoming, ON duration. In some embodiments, the information is transmitted in specific ON duration for adjustment of that specific ON duration. In some embodiments, the information is transmitted in an early indication signal, transmitted between ON durations according to the DRX configuration. Configuration of a window for monitoring the early indication signal in the UE 10 may be transmitted by the access node 121 in a preceding ON duration, or as part of DRX configuration 510.

In step 550, the access node 121 transmits the data to the UE 10 according to the adjusted timing, said UE 10 being configured according to the adjusted timing.

The UE 10 may be explicitly configured with the adjusted timing, e.g. on a per ON duration basis, according to step 540. Alternatively, the UE 10 may be configured to autonomously identify the adjusted timing, either by default pre-configuration and based on the traffic information, or based on an identified scheme according to step 530.

With reference to FIG. 5, the proposed solution thus inter alia provides a method carried out in an access node 121 of a wireless network 100 for managing configuration of discontinuous reception (DRX) for UE, said DRX configuration comprising ON durations repeated with a DRX cycle, wherein the method comprises:
obtaining 530 adjusted timing for the ON durations based on traffic information of data for the UE; and
transmitting 550 the data to the UE according to the adjusted timing, said UE being configured according to the adjusted timing.

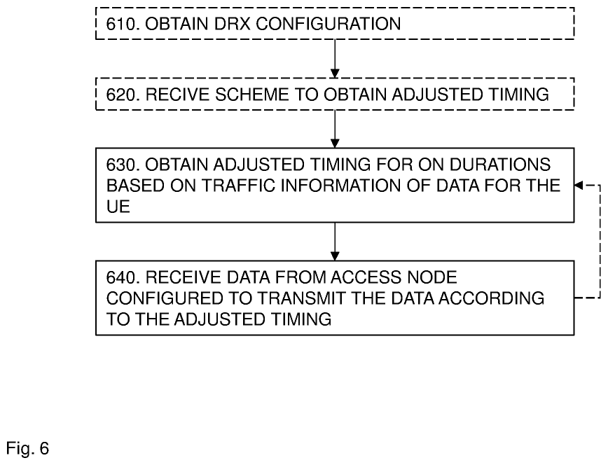

FIG. 6 shows a flowchart of a general presentation of a method carried out in the UE 10, configured to communicate with the wireless network 100, according to the proposed solution.

In optional step 610 the UE 10 obtains a DRX configuration.

The UE 10 may be pre-configured with the DRX configuration, by specified default or based on other input, such as based on characteristics of data to be received, e.g. identified by application type. As an alternative, the UE 10 may receive the DRX configuration from the wireless network 100, such as from the access node 121. The DRX configuration comprises timing data and radio parameters for identifying ON durations repeated with a DRX cycle. In some embodiments, the DRX configuration may comprise multiple DRX configurations, with respective ON durations repeated with DRX cycles which may be different. The DRX configuration may be a connected mode DRX configuration (C-DRX), e.g. as short C-DRX according to legacy 3GPP specifications.

In optional step 620, which may form part of certain embodiments, the UE 10 is configured by the access node 121 to obtain adjusted timing for adaptation of ON durations of the DRX configuration. This step may include receiving information from the access node 121, which information identifies a scheme for determining the adjusted timing in the UE 10. This information may in some embodiments comprise traffic information associated with the data traffic intended for the UE 10 using the DRX configuration. Additionally, or alternatively, the information may identify an algorithm usable by the UE 10 for timing adjustment of ON durations of the DRX configuration. The UE 10 is thus configured to subsequently determine timing adjustment of each ON duration based on the received information.

In step 630, the UE 10 obtains adjusted timing for the ON durations based on traffic information of data for the UE 10.

This step may be obtained by receiving the adjusted timing from the access node 121, or another node of the wireless network 100, wherein the UE 10 is explicitly configured with the adjusted timing. Alternatively, the UE 10 may be configured in step 620 to autonomously identify the adjusted timing in step 630, based on the traffic information or based on an identified scheme. The traffic information may provide identification of an application or service type for which the data traffic is to be communicated. Alternatively, the traffic information provides information of one or more data flows, in which the data traffic will be communicated. The traffic information may inter alia identify a periodicity of the data traffic. In some examples, the traffic information may identify jitter associated with the data traffic, which may be measured by a node of the wireless network or conveyed as an estimate associated with the data traffic. The adjusted timing may refer to a specific ON duration, or a scheme for successively adjusting the ON durations according to a predetermined rule.

In step 640, the UE 10 receives the data from the access node 121 according to the adjusted timing, wherein the access node 121 is configured to transmit the data according to the adjusted timing.

With reference to FIG. 6, the proposed solution thus inter alia provides a method carried out in a UE 10 for managing configuration of discontinuous reception (DRX), said DRX configuration comprising ON durations repeated with a DRX cycle, wherein the method comprises:
obtaining 630 adjusted timing for the ON durations based on traffic information of data for the UE 10; and
receiving 640 the data from an access node 121 of a wireless network 100, said access node 121 being configured to transmit the data according to the adjusted timing.

By means of the proposed solution, as broadly identified with reference to FIGS. 5 and 6, procedures are provided for reducing energy consumption in the UE 10 at DL channel monitoring with DRX, and for more efficient use of the air interface. Specifically, the proposed solution provides means for handling non-integer periodicity of packet arrival rate and jitter in data traffic, associated with e.g. XR applications. Various embodiments and examples related to the general proposed solution will be outlined going forward.

As noted, the proposed solution involves obtaining adjusted timing for the ON durations of the DRX configuration, based on traffic information of data for the UE 10. In this context, the traffic information may be indicative of expected packet arrival time of the data, also referred to herein as periodicity of the data traffic, e.g. frame rate of one or more data flows. The proposed solution may in various embodiments be usable to obtain the adjusted timing so as to accommodate for misalignment of the expected arrival time and the DRX configuration.

The applied DRX configuration may additionally be determined based on the traffic information, or based on legacy procedures. In some examples of the proposed solution, the DRX configuration may comprise a legacy type DRX configuration, such as long DRX or short DRX for connected mode operation. In various examples of the proposed solution, traffic information of the data intended for the UE 10 may identify the DRX configuration. In some embodiments, the access node 121 may receive traffic information that contains or points to a certain determined DRX configuration, which may have been identified in the core network 110. In other embodiments, the access node 121 receives the traffic information and makes a determination to establish the DRX configuration to employ.

The traffic information may comprise data flow information of said data traffic, such as data associated with active data flows. The data flow information may identify at least frame rate of one or more data flows of the data traffic. The data flow information may further identify number of data flows, and optionally data rate of the one or more data flows of the data traffic. In some embodiments, as outlined and described herein by a variety of examples, obtaining the adjusted timing may involve determining an advanced or delayed starting time for one or more ON durations, compared to the configured DRX configuration. Moreover, selecting the DRX configuration may involve determining, by the access node 121, one of a plurality of different DRX configurations based on the data flow information. This may involve selecting a best suited DRX configuration, with a DRX cycle selected dependent on a periodicity of the data traffic.

In some examples, the traffic information comprises application information of said data traffic. In this context, the application information may identify an application type, such as VR, AR, etc., or a group ID associated with a sort of application, or may uniquely identify an application. The access node 121 may further be configured to determine or identify the timing information and optionally select the determined DRX configuration, based on the application information. The application information may, explicitly or implicitly, identify frame rate of one or more data flows. The application information may further identify number of data flows, and optionally data rate one or more data flows of the data traffic. In one embodiment, the application information may identify the UE 10, or a UE context in the application, associated with the UE 10, which is cashed in a network node of the wireless network 100, in or accessible to the access node 121. The cashed information may tie a certain rule or scheme for determining the timing adjustment and/or the DRX configuration to be used for the UE 10, or for data traffic associated with a certain application for that UE 10. The access node 121 may in such a case be arranged to select the scheme for determining the timing adjustment, and/or a DRX configuration, based on the cashed information.

In the context of the example of the traffic information comprising application information, a mapping of an application and an associated required number of streams may be defined, which mapping is usable in the access node 121, or another node of the wireless network 100, to identify data flow information related the application information. For the example of XR, this mapping may comprise an identification of expected number of data flows/streams for each XR application, such as VR, AR, CG. An example of this is shown in Table 1 below which provides mapping between application, or application type, and flows with one or more flow parameters. Each application type is identified by an application ID which may identify a type or group of applications. The timing adjustment and the DRX configuration may be determined based on the mapping, wherein the traffic information may contain the ID.

TABLE 1

| | | | Parameter 1 | Parameter 2 |
|---|---|---|---|---|
| | | | (Frame rate/ | (Data |
| ID | Application | Flows | Periodicity) | rate-Mbps) |
| 1-1 | VR | 1 | 30 fps | 20 |
| 1-2 | | 2 (I-frame & | 60 fps | 10 & 20 |
| | | P-frame) | | |
| 1-3 | | 2 (Video & | 30 fps, 10 ms | 20 & 2 |
| | | Audio/Data) | | |
| 2-1 | CG | 1 | 120 fps | 30 |
| 2-2 | | 2 (I & P) | 60 fps, 10 ms | 8 & 14 |
| 3-1 | AR | 1 | 60 fps | 10 |
| 3-2 | | 2 (Video & | 30 fps, 10 ms | 30 & 2 |
| | | Audio/Data) | | |

In some examples, the parameter 1 may be used as input to select the determined DRX configuration, such that ON durations have a matching cyclic behavior with regard to the frame rate.

The determined DRX configuration may be dependent on the traffic information of incoming data for the UE, and may further be based on traffic condition and packet arrival time. The possible DRX configuration for each stream and possible combination of DRX configurations for multiple streams can be predefined, based on characteristics of the traffic information. In some embodiments, a core network node, such as the UPF 103 or other support function, analyses incoming data traffic from the AF to identify its character, such as number of flows and associated frame rates. The core network node may thereby define the traffic information, based on the identified character. In some embodiments, the traffic information, identifying flows and associated parameters, is obtained in the core network 110 from application layer to radio layer.

Various examples of arranging the adjusted timing according to the proposed solution will now be described with reference to the drawings. This relates to procedures on how to handle non-integer periodicity of packet arrival rate and jitter in the data traffic, e.g. associated with an XR application, when configuring the DL channel monitoring with DRX.

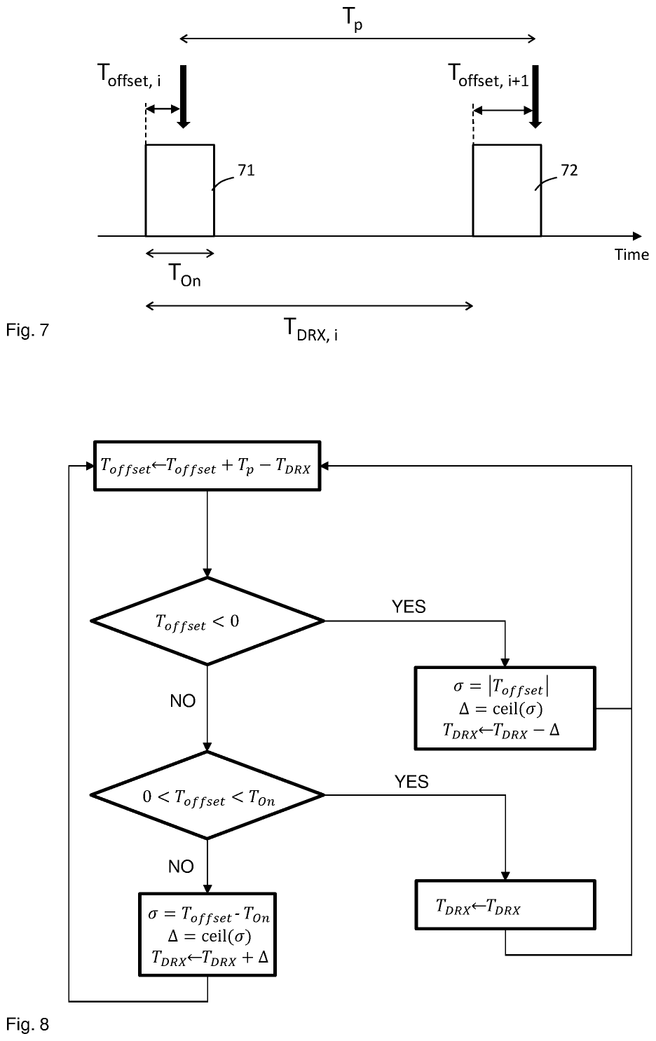

The procedure described with reference to FIGS. 7-10 relate to adaptively delaying or advancing the start of the ON duration.

FIG. 7 schematically illustrates a result of the misalignment as broadly described earlier with reference to FIG. 4, and associated parameters. In FIG. 7, a first ON duration 71 is shown, as well as a second upcoming, next, ON duration 72. According to the applied DRX configuration, these ON durations have configured intended starting points separated by the DRX cycle T_{DRX, i}. The expected packet arrival time is indicated by the downwards-pointing arrows, separated by the periodicity T_{P}, which may be given by, or determined based on, the traffic information. In the scenario where T_{P} and T_{DRX, i} do not match, an offset T_{offset} between the intended starting point of the ON duration and the expected packet arrival time will not be constant from one ON duration 71 to the next 72. For this purpose, the proposed solution may in various embodiments involve applying an adjusted timing for the ON durations, so as to accommodate for this mismatch causing an evolving T_{offset}.

According to some embodiments, the adjusted timing identifies a starting point of the next ON duration 72 which is offset by an adjustment time Δ from an intended starting point according to the DRX configuration.

According to some examples, a calculation rule or scheme for determining whether to delay or advance the start of the ON duration is based on the following:

$${T}_{DRX , i} ← \{ \begin{matrix}{T}_{DRX , i} − Δ , & {T}_{offset , i + 1} < 0 \\ {T}_{DRX , i ,} & 0 < {T}_{offset , i + 1} < {T}_{o n} \\ {T}_{DRX , i} + Δ , & {T}_{offset , i + 1} > {T}_{o n}\end{matrix}$$

$$where$$

$${T}_{offset , i + 1} = {T}_{offset , i} + {T}_{p} − {T}_{D R X , i} ,$$

$$Δ = ceil ( σ ) , and$$

$$σ = \{ \begin{matrix}\vert {T}_{offset , i + 1} \vert & {T}_{offset , i + 1} < 0 \\ {T}_{offset , i + 1} − {T}_{o n} & {T}_{offset , i + 1} > {T}_{o n}\end{matrix} .$$

FIG. 8 shows the applied rule for determining the adjusted timing based on the example above. In plain text, this example of a scheme for determining the adjusted timing provides that if the next packet arrival time is earlier than the intended starting time of the upcoming, next, ON duration 72, that ON duration 72 is advanced by the adjustment time Δ. If, on the other hand, the next packet arrival time is later than the active period of the ON duration 72, e.g. as determined by an expiry of an inactivity timer of the ON duration 72, then the ON duration 72 is delayed by the adjustment time Δ. Where the packet arrival time is deemed to occur within the active period of the ON duration 72, no adjustment time is applied. The adjustment time Δ may be predetermined, based on the DRX configuration. In the provided example, the adjustment time Δ is further configured based on the periodicity Tₚ. The adjustment time Δ may comprises a difference σ between expected packet arrival time for the data and the intended starting point of the next ON duration. The actual adjustment time Δ which is applied may be rounded up based on a resolution of the DRX configuration, such as to the nearest millisecond. Where the adjustment time is applied, the preceding DRX cycle will thus be adjusted. In some embodiments, an intended starting point for a subsequent ON duration, after ON duration 72, will be scheduled at one DRX cycle from the ON duration 72 which has been configured according to the adjusted timing. This way, an offset is made to the DRX configuration. In an alternative embodiment, the access node 121 and the UE 10 will maintain the configured DRX configuration, and repetitively sum/accumulate the timing adjustments made for any preceding ON duration 71, 72 and earlier.

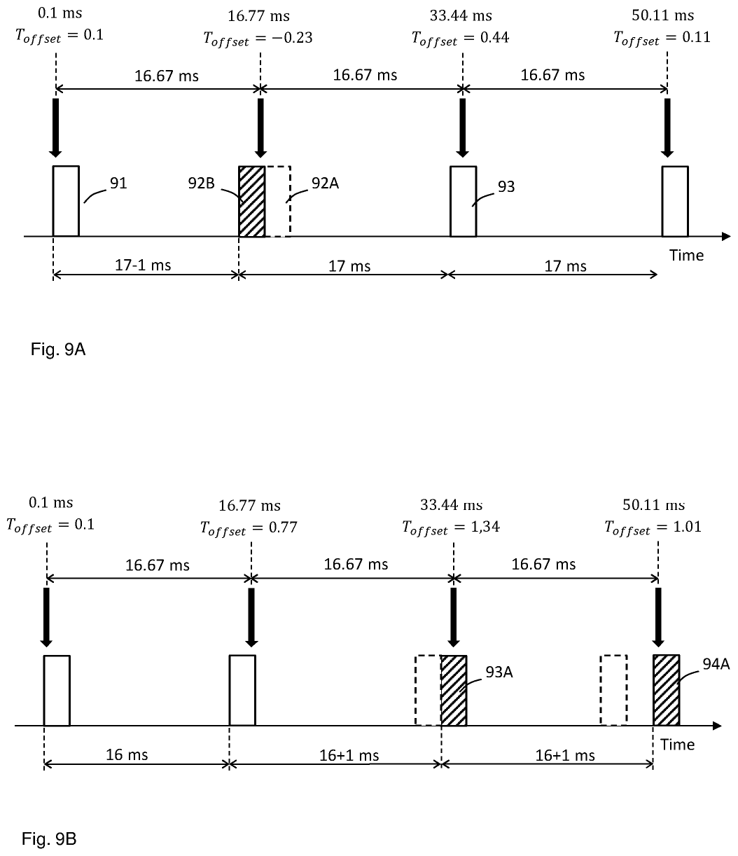

FIGS. 9A and 9B schematically illustrate examples of advancing and delaying the start of ON duration, respectively, for data traffic with 60 frame per second (fps) resulting in a periodicity T_{P} for packet arrival time of 16.67 ms. In correspondence with FIG. 4, the downwards-pointing arrows indicate expected packet arrival time based on the periodicity Tₚ. White boxes indicate the configured DRX ON durations, e.g. according to short C-DRX, whereas the patterned boxes indicate ON durations according to the adjusted timing. The left edge of the respective box marks the intended starting point of the respective ON duration. ON duration is configured to 1 ms.

In the example of FIG. 9A, the DRX length is set to 17 ms, which is the closest integer ms DRX cycle with respect to the periodicity Tₚ. In an embodiment where the DRX cycle is determined based on the traffic information, the DRX length/cycle is set to an integer value 17 ms, calculated by rounding up the non-integer packet arrival interval of the data traffic, e.g. an XR type, to its nearest integer value. In the shown example, expected packet arrival time is at an offset of 0.1 ms after start of the first shown ON duration 91. Consequently, the next (second) packet arrival time will be earlier than the intended starting point of the next ON duration 92A. For this reason, and following the described example as provided in FIG. 8, adjusted timing will be applied to the next ON duration to advance the starting time by an adjustment time Δ, such that the adjusted next ON duration 92B starts 1 ms earlier. The subsequent ON duration 93, following the adjusted second ON duration 92B will have an intended starting point at 17 ms from the adjusted starting point of ON duration 92B.

In the example of FIG. 9B, The DRX cycle length is configured to 16 ms. In an embodiment where the DRX cycle is determined based on the traffic information, the DRX length/cycle is set to an integer value an integer value 16 ms, calculated by rounding down the non-integer packet arrival interval of the data traffic, e.g. an XR type, to its nearest integer value. The proposed solution according to this example will cause adjustment of the starting time of the 3rd 93A and 4th 94A ON durations to match with arrival of the data packets.

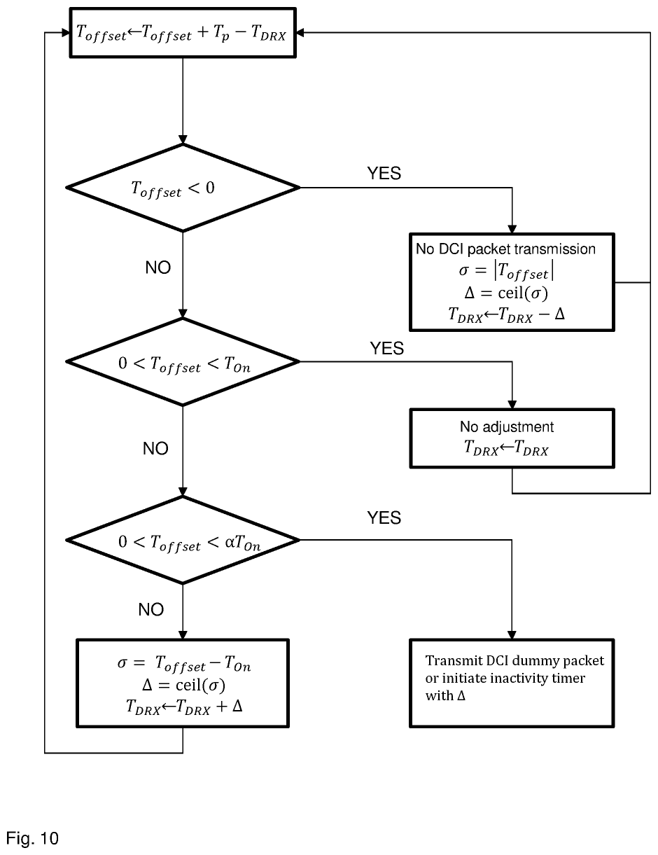

According to some embodiments, in the scenario of expected packet arrival delay relative to the DRX active period of the ON duration, a combined solution is applied, where the timing adjustment either identifies an advance/delay of the start of the ON duration, or extension of the monitoring period of the ON duration. The latter may be obtained by transmitting a dummy packet in DL from the access node 121, e.g. a DCI, during the ON duration, which causes an inactivity timer in the UE 10 to maintain monitoring in accordance with that timer. Alternatively, DCI (Downlink Control Information) may be transmitted by the access node 121, indicating to the UE 10 to initiate an inactivity timer with value A. FIG. 10 schematically illustrates a variant of the algorithm of the scheme of FIG. 8, where extension of the monitoring time is further included. Specifically, in this example, a delay of the expected packet arrival time with respect to the intended ON duration is evaluated, wherein an extension of the monitoring time is applied if the delay is within a certain margin αTₒₙ. This margin αTₒₙ. may be determined by the access node 121, or determined based on specification, based on e.g. the applied DRX configuration. The margin αTₒₙ. may e.g. be a fraction of Tₒₙ, such as ½ Tₒₙ or equal to Tₒₙ.

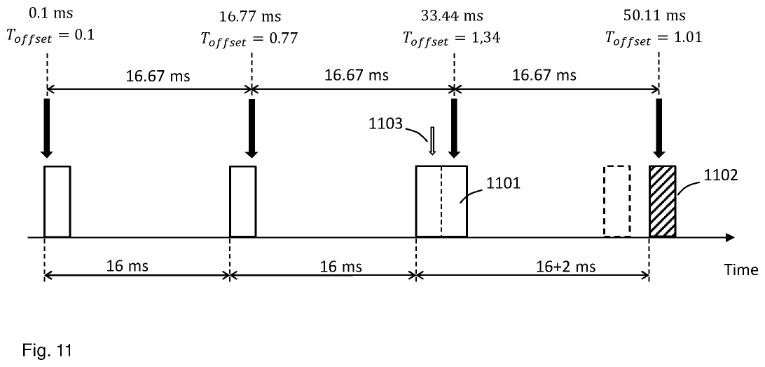

FIG. 11 schematically shows an example of this combined approach, operated according to the scheme of FIG. 10. The scenario is otherwise comparable to that of FIG. 9B, where data traffic is provided with 60 frame per second (fps) resulting in packet arrival time of 16.67 msec and a DRX configuration of 16 msec, which means that the expected packet arrival time will eventually be delayed compared to the DRX configuration if no timing adjustment is made. As an example, the ON duration 1101 has a starting point with an offset which is more than Tₒₙ but less than the margin αTₒₙ, with reference to the expected packet arrival time. The timing adjustment thus provides for extension of the monitoring time (original end of Tₒₙ being indicated by a dashed line). This timing adjustment may, as noted, be carried out by transmission 1103 of information such as a dummy packet, from the access node 121 to the UE during the unadjusted monitoring time of the ON duration according to the DRX configuration. Since no delay of the starting time is made in that ON duration 1101, the next ON duration 1102 will be further offset from the intended starting time. The starting time of the next ON duration 1102 will therefore be adjusted by 2 ms in this example. With the combined solution of FIG. 11, once adjustment begins, every 2nd cycle the ON duration is extended and every 3rd cycle the start of the ON duration is delayed.

While FIGS. 10 and 11 shows examples, it may thus be noted that the method according to the proposed solution is in some embodiments configured such that the adjusted timing identifies either:
a) an extension of monitoring time of a next ON duration, responsive to expected packet arrival time of the data occurring within a preconfigured period αTₒₙ. later than an intended starting point of the next ON duration according to the DRX configuration, as exemplified for ON duration 1101, or
b) a starting point of a next ON duration which is offset by an adjustment time (A) from an intended starting point according to the DRX configuration, as exemplified for ON duration 1102.

In some embodiments, the access node is configured to determining the adjusted timing based on measured jitter on a communication link for receiving the data. In some examples, the access node 121 may be arranged to perform measurement on the jitter, such as maximum detected jitter. Alternatively, the access node 121 may obtain this information from the core network 110. The measured jitter may be expressed as a level of fluctuation, such as a maximum detected deviation from the default packet arrival rate of the data traffic of the application. The expected packet arrival time may thus be determined to precede the default packet arrival time, determined based on periodicity of the data traffic, by the detected deviation. In other examples, the jitter may continuously be measured, to obtain an actual deviation from the default packet arrival time for an upcoming On-duration, on a per ON duration basis.

The access node 121 may be configured to transmit an indication of the measured jitter to the UE 10. This may form part of the traffic information for the data traffic, or be provided separately, e.g. responsive to detected packet timing accuracy detected in the network 100. The UE 10 can thus adjust the ON durations accordingly. Notably, the correction may be carried out responsive to misalignment caused by jitter as such, or jitter in combination with a default mismatch between the configured DRX cycle and the frame rate of the data traffic. If a data packet due to jitter arrives earlier than the ON duration, e.g. calculated based on above techniques, the ON duration is advanced based on the measured jitter level. If jitter causes a packet to arrive after the ON duration, then the ON duration is postponed or extended.

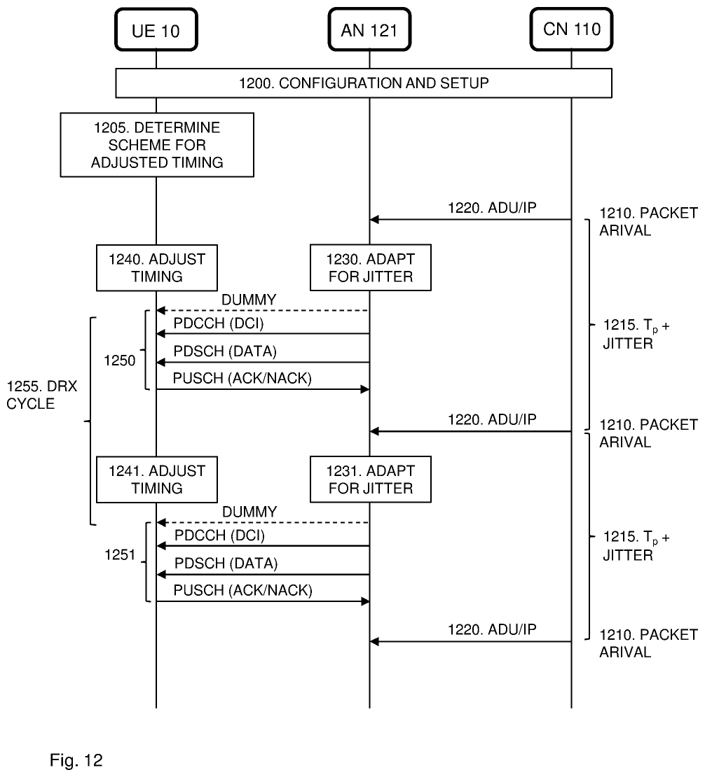

In some embodiments, explicit indication of adjusted timing is not provided by the access node 121 to the UE 10 on an ON duration basis. Rather, the UE 10 is configured with a scheme to autonomously determine the timing adjustment for the ON durations. Where a general level of jitter of the incoming data traffic can be assessed in the network, such as a level of time fluctuation caused by jitter, the access node 121 may further configure the UE 10 to apply a scheme that successively adapts the DRX ON durations to accommodate for such level of jitter. Alternatively, the DRX configuration may as such be determined by the access node 121 to accommodate for the assessed level of jitter, e.g. with a ON durations and/or DRX cycles selected such that misalignment due to jitter will not or is less likely to occur. The access node 121 will then configure the UE 10 accordingly. Alternatively, as described e.g. with reference to FIG. 12 below, the access node 121 may further measure actual jitter and send DL information, e.g. a dummy packet, where the jitter causes a delay of the data packet arrival.

The solution proposed herein may in various embodiments benefit from additional signaling based on the traffic awareness. The RAN 120 has historically been designed to be service-agnostic, wherein functions and enhancements usually are not linked to a specific service or application. With introduction of new services and applications whose traffic characteristics and requirements are different from those of the traditional services and applications, the RAN 120 may advantageously be configured to improved performance by gaining better understanding of application and what traffic pattern it may generate. This may e.g. be the case for services and applications, such as data flows of XR applications, where expected packet arrival rate is more or less deterministic. The proposed solution as described herein provides one example where such improvement may be obtained, where benefit is obtained in terms of energy conservation in the UE 10, and improved use of the air interface by avoiding skipping of DL transmission in ON durations that do not align with the packet arrival rate of the data traffic. As already noted, the traffic information used for determining the timing adjustment as proposed herein, and potentially also the particular DRX configuration to apply, may be determined by the access node 121 or obtained in the access node 121 from another node of the wireless network, such as a core network node, or be provided as UE assistance information from the UE 10 based on the application executed to provide the data traffic.

According to some examples, a mechanism is introduced for the Application layer to inform the Radio layer of application-specific traffic behavior. Based on such traffic information, the capability of the RAN or specifically the access node 121 may be enhanced, so as to better determine or tailor scheduling mechanisms, like C-DRX patterns and schemes for timing adjustment. There may be different options on how to relate the DRX scheme to traffic pattern behavior, which may cooperate to improve obtainment of the traffic information. According to one aspect, an indication may be provided from application layer, identifying traffic information about what traffic behavior is expected, e.g. a video oriented data stream with a certain FPS rate, jitter tolerance, max packet size, max data rate, etc. According to another aspect, the access node 121 and/or the UE 10 may be configured to learn traffic behavior and activate or adjust timing adjustment based on experience during an ongoing session. According to yet another aspect, the access node 121 may have an artificial intelligence (AI) or machine learning (ML) model stored, that can enhance its learning about certain traffic behavior, and how to optimize its scheduler based on multiple stored traffic sessions from multiple users (UEs). Configuration to obtain the traffic information may be provided at setup of PDU session/RRC connection, from the access node 121 to the UE 10: alternatively, obtainment of the traffic information may be carried out via application layer signaling and then horizontally and implementation-specific handled between application layer and the UE modem comprising the transceiver 213, and the base station 121, respectively.

As noted with reference to FIGS. 5 and 6, the access node 121 on which the UE 10 is camping may explicitly configure the UE 10 to apply the adjusted timing. In some embodiments, this may be obtained by supplying 530 a scheme or rule, e.g. to operate according to the algorithm of FIG. 8 or 10, which is received 620 in the UE. In some embodiments, the scheme may be predetermined to apply based on traffic information related to certain data traffic, such as a certain XR application, or application type, where e.g. frame rate is known. The scheme may thus for instance provide a predetermined cyclic behavior extending over a number of ON durations. As an example, based on the embodiment described with reference to FIG. 8, the scheme may prescribe that after a first unadjusted ON duration, the starting time of two successive ON durations shall be postponed, e.g. by 1×Δ counted from actual starting time of the respective preceding ON duration. As another example, based on the embodiment described with reference to FIG. 10, the scheme may prescribe that every third ON duration is postponed, e.g. by 2×Δ counted from actual starting time of the respective preceding ON duration. For the ON duration preceding the postponed ON duration, a dummy packet may be transmitted in DL to extend the monitoring time. In alternative embodiments, the UE 10 may be independently configured to determine how to apply the adjusted timing, e.g. based on an application for which the data traffic is to be received, as exemplified above with regard to an indication identifying the traffic information obtained from the application layer. In any of these examples, the UE 10 is configured to autonomously apply the received 620 scheme for each DRX cycle. In some embodiments, initial signaling, by RRC or lower layer DCI, by the access node 121 may provide an initial offset value T_{offset} in order for a processing function operated by the logic circuitry 210 in the UE 10 to determine subsequent adjustment on a per ON duration basis. In other embodiments, the access node 121 may provide control signaling on a per ON duration basis, by transmitting 540 information identifying the adjusted timing, which information is received 630 in the UE 10 and subsequently applied to monitor the ON durations according to the adjusted timing. Various examples related to these different embodiments will be described below.

FIG. 12 shows a signaling diagram of an embodiment of the proposed solution, wherein an implicit approach is provided for timing adjustment of ON durations of a DRX configuration.

A stage 1200 of configuration and setup is initially provided. According to some embodiments, a capability of the UE 10, and possibly also of the access node 121, in an initialization phase of stage 1200. This may include the access node 121 and the UE 10 declaring whether or not they support adaptation of DRX configuration to advance/delay/extend according to the proposed solution. Such a declaration of capability may be a prerequisite to proceed in accordance with this signaling diagram.

The configuration and setup stage 1200 comprises steps required for configuring the UE 10 with a connected mode DRX configuration for use in at least DL communication of data traffic related to a service or an application, such as an XR application. This correlates to step 510 of FIG. 5 and step 610 of FIG. 6. This may be accomplished according to legacy procedures. In stage 1200, the access node 121 obtains information on adjusted timing to apply to the DRX configuration, based on traffic information. This may correlate with step 520 of FIG. 5. This information may comprise a scheme to apply for adapting the DRX configuration, such as to apply adjusted timing for ON durations of the DRX configuration. As noted, the access node 121 may be configured to determine the adjusted timing based on traffic awareness, wherein the traffic information may comprise an indication of the service or application. Alternatively, the traffic information may identify a scheme to apply for determining the adjusted timing. The traffic information may e.g. be received by the access node 121 from the core network 110.

The configuration and setup stage 1200 further configures the UE 10 with the scheme for applying timing adjustment to adapt the DRX, according to the proposed solution, as identified by step 530 of FIG. 5 and step 620 of FIG. 6. As noted earlier herein, this may include transmitting an indication of the scheme to apply, for example as exemplified with reference to FIGS. 8-11. In some embodiments, this may include transmitting, from the access node 121 to the UE 10, parameters for the timing adjustment, such as the adjustment time Δ, and possibly an identified starting point for an ON duration of the DRX configuration, such as a system frame number (SFN) number, e.g. pointing to the first sub-frame/slot and first OFDM symbol of that SFN. In some embodiments, traffic information associated with the service or application is transmitted from the network 100 to the UE, or from an application layer in the UE 10, wherein the UE 10 is explicitly or implicitly configured to determine the DRX configuration based on the traffic information. The traffic information may also identify the parameters for the timing adjustment. In some embodiments, the configuration and setup stage 1200 further comprises identifying a level of jitter in the wireless network 100, and informing the UE 10.

It shall thus be understood that the configuration and setup stage 1200 may comprise several steps of signaling, including e.g. capability signaling from the UE 10, and subsequent signaling of DRX configuration and a scheme for applying timing adjustment. Updated signaling, within the context of the configuration and setup stage 1200, may be carried out later while the UE is running the application, e.g. for updating the UE with regard to changes in traffic information.

In step 1205, the UE 10 determines the scheme to apply for adapting the DRX configuration, such as to apply adjusted timing for ON durations of the DRX configuration. As noted, this may be carried out based on information obtained in the preceding stage 1200, which may explicitly identify the scheme and associated parameters, or which may comprise traffic information based on which the UE 10 determines 1205 the scheme. In some embodiments, this also includes adapting the starting time of ON durations based on the level of measured jitter, where a level of jitter is transmitted 1200 to the UE 10.

Upon running the service or application, which provides data traffic with an expected packet arrival time determined by e.g. a frame rate, packet arrival 1210 to the network 100 will occur with a certain periodicity Tₚ 1215 associated with the frame rate. The packet arrival time may further be affected by jitter. The data packets will be conveyed 1220 from the core network 110 to the access node 121 in e.g. application data units (ADU) or IP packets, in accordance with the packet arrival time.

The access node 121 will transmit the data to the UE 10 in accordance with the DRX configuration, including applying adaptation to starting time of the ON durations according to the determined adjusted timing. In an embodiment where the access node 121 is configured to determine a measured level of jitter in the data packet arrival time, a step 1230, the access node may further apply timing adjustment to compensate for the measured jitter. This may comprise transmitting a dummy packet to extend monitoring time of the ON duration, as mentioned and illustrated. This may form part of step 540 of FIG. 5 and step 630 of FIG. 6 in various embodiments.

In step 1240, the UE 10 adapts, where applicable based on the scheme, the starting time for the next ON duration, in which ON duration the UE 10 communicates 1250 with the access node 121. This may include, according to legacy procedures, receiving DCI on a physical downlink control channel (PDCCH), receiving the data in a physical downlink shared channel (PDSCH), and providing acknowledgement on a physical uplink shared channel (PUSCH). This correlates to step 550 of FIG. 5 and step 640 of FIG. 6.

This process is subsequently repeated for each DRX cycle 1255 in which packet arrival occurs, wherein the process steps 1231, 1241, and 1251 are indicated for the next cycle in FIG. 12. As starting time of the ON durations are adjusted, also the actual DRX cycle 1255 may be adjusted where the preceding ON duration has been delayed or advanced according to the proposed solution.

By means of implicit operation based on a certain scheme, the UE 10 is configured to autonomously re-adjust its DRX parameters without requiring additional signaling from the network 100.

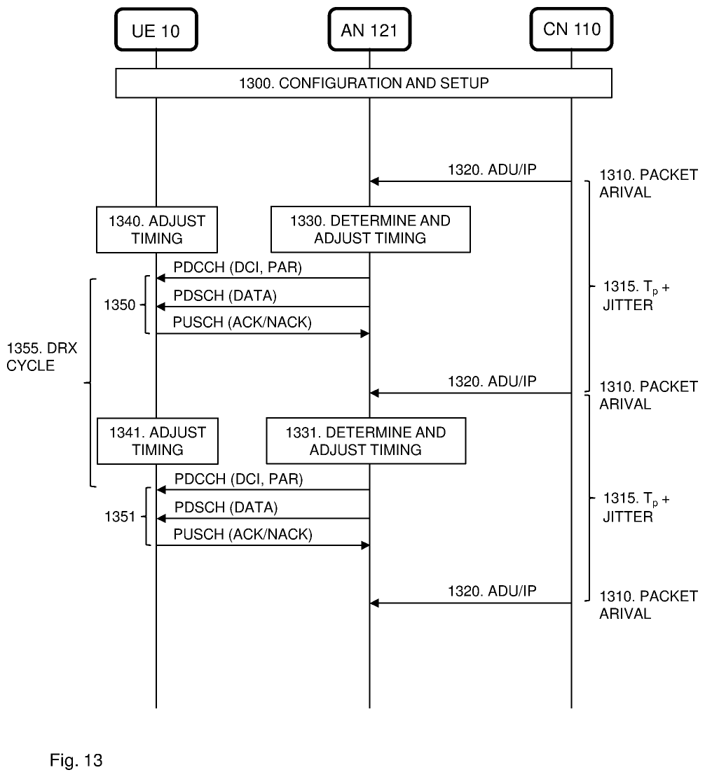

FIG. 13 shows a signaling diagram of an embodiment of the proposed solution, wherein a more explicit approach is provided for timing adjustment of ON durations of a DRX configuration.

A stage 1300 of configuration and setup is initially provided. According to some embodiments, a capability of the UE 10, and possibly also of the access node 121, in an initialization phase of stage 1300. This may include the access node 121 and the UE 10 declaring whether or not they support adaptation of DRX configuration to advance/delay/extend according to the proposed solution. Such a declaration of capability may be a prerequisite to proceed in accordance with this signaling diagram.

The configuration and setup stage 1300 comprises steps required for configuring the UE 10 with a connected mode DRX configuration for use in at least DL communication of data traffic related to a service or an application, such as an XR application. This correlates to step 510 of FIG. 5 and step 610 of FIG. 6. This may be accomplished according to legacy procedures. In stage 1300, the access node 121 obtains information on adjusted timing to apply to the DRX configuration, based on traffic information. This information may comprise a scheme to apply for adapting the DRX configuration, such as to apply adjusted timing for ON durations of the DRX configuration. As noted, the access node 121 may be configured to determine the adjusted timing based on traffic awareness, wherein the traffic information may comprise an indication of the service or application. Alternatively, the traffic information may identify a scheme to apply for determining the adjusted timing. The traffic information may e.g. be received by the access node 121 from the core network 110.

The configuration and setup stage 1300 may further configure the UE 10 to receive information for applying timing adjustment to adapt the DRX on a per ON duration basis, according to the proposed solution. In some embodiments, the configuration and setup stage 1300 further comprises identifying a level of jitter in the wireless network 100, and informing the UE 10. This configuration and setup stage may further include transmitting an indication of the scheme to apply, for example as exemplified with reference to FIGS. 8-11. In some embodiments, this may include transmitting, from the access node 121 to the UE 10, parameters for the timing adjustment, such as the adjustment time Δ, and possibly an identified starting point for an ON duration of the DRX configuration, such as a system frame number (SFN) number, e.g. pointing to the first sub-frame/slot and first OFDM symbol of that SFN.

Upon running the service or application, which provides data traffic with an expected packet arrival time determined by e.g. a frame rate, packet arrival 1310 to the network 100 will occur with a certain periodicity Tₚ 1315 associated with the frame rate. The packet arrival time may further be affected by jitter. The data packets will be conveyed 1320 from the core network 110 to the access node 121 in e.g. application data units (ADU) or IP packets, in accordance with the packet arrival time.

In step 1330 the access node 121 determines the need to adjust timing, to handle misalignment between packet arrival and the DRX configuration and/or jitter. The scheme to use for determining the adjusted timing may have been obtained in stage 1300, e.g. from the core network, or be determined by the access node 121 based on the traffic information, as described. In some embodiments, traffic information associated with the service or application explicitly or implicitly determines the DRX configuration and/or identifies parameters for use in the timing adjustment 1330. The adjusted timing determined in step 1330 correlates with step 520 of FIG. 5. If jitter is experienced, this is also handled by the access node 121. Where the determined timing adjustment implies a delay or advancement of ON duration starting point, this will apply to the next ON duration.

In step 1350, the UE 10 monitors the ON duration according to the DRX configuration, possibly adapted based on a received timing adjustment (indicated by preceding step 1340). In the ON duration, the UE 10 communicates with the access node 121. This may include, according to legacy procedures, receiving DCI on a physical downlink control channel (PDCCH), receiving the data in a physical downlink shared channel (PDSCH), and providing acknowledgement on a physical uplink shared channel (PUSCH).

Furthermore, the UE 10 receives information identifying adjusted timing for a next ON duration 1351. This information is identified herein as PAR herein, and indicated, by way of example as PAR transmitted in DL in PDCCH. This correlates to step 540 of FIG. 5 and step 630 of FIG. 6. Where the timing adjustment identifies extension of the monitoring time, the information PAR may comprise a dummy packet, serving to extend the monitoring time 1350 of the present ON duration. This information PAR may e.g. be provided in DCI or DL MAC CE.

Based on the information PAR, the UE 10 is configured to apply 1341, where so configured by the information PAR, adjusted timing to the next ON duration, monitored in step 1351, which may imply either delaying or advancing the starting point of that next ON duration. The UE 10 will receive data, transmitted by the access node 121, in the next ON duration 1351, which may be adapted according to the received information PAR identifying the timing adjustment. This corresponds to step 550 of FIG. 5 and step 640 of FIG. 6.

This process is subsequently repeated for each DRX cycle 1355 in which packet arrival occurs. As starting time of the ON durations are adjusted, also the actual DRX cycle may be adjusted where the preceding ON duration has been delayed or advanced according to the proposed solution.

By means of explicit DL transmission 540, 630 of information PAR identifying timing adjustment, the UE 10 is configured to re-adjust its DRX parameters with limited processing required by the UE 10.

In various embodiments, the information PAR which identifies the timing adjustment, serves to notify the UE 10 whether to re-arrange the start of the ON duration and, where applicable, how and for how long. In one embodiment, the information PAR comprises a combination of any of the following information, which is transmitted in the ON duration, e.g. as DL DCI:

PAR_A: Adjustment direction. This indicator may be read in the UE 10 and used to determine whether advance or delay of the starting time of the next ON duration shall be made. This may be conveyed by 1 bit.

PAR_B: A value on how long to delay or advance-L bit, dependent on the precision of the number to be indicated. Each bit can represent a time unit, which may be configured in the configuration stage 1600 and informed to the UE 10. For example, 1 bit may represent a time slot or N time slots. It may also depend on the operated subcarrier spacing (SCS).

PAR_C: An indicator to extend the On-duration, due to jitter, as an alternative to transmit a dummy packet.

According to various embodiments of the proposed solution, explicit signaling to provide information PAR identifying timing adjustment is carried out by transmitting an early indication signal from the access node 121 to the UE 10. The early indication signal, abbreviated EIS going forward for the sake of brevity, is transmitted in advance of the DRX ON duration. The transmitted EIS is configured to comprise information PAR identifying timing adjustment, thus configuring the UE 10 to rearrange the DRX configuration adaptively, ensuring proper reception of data packets at the UE side.

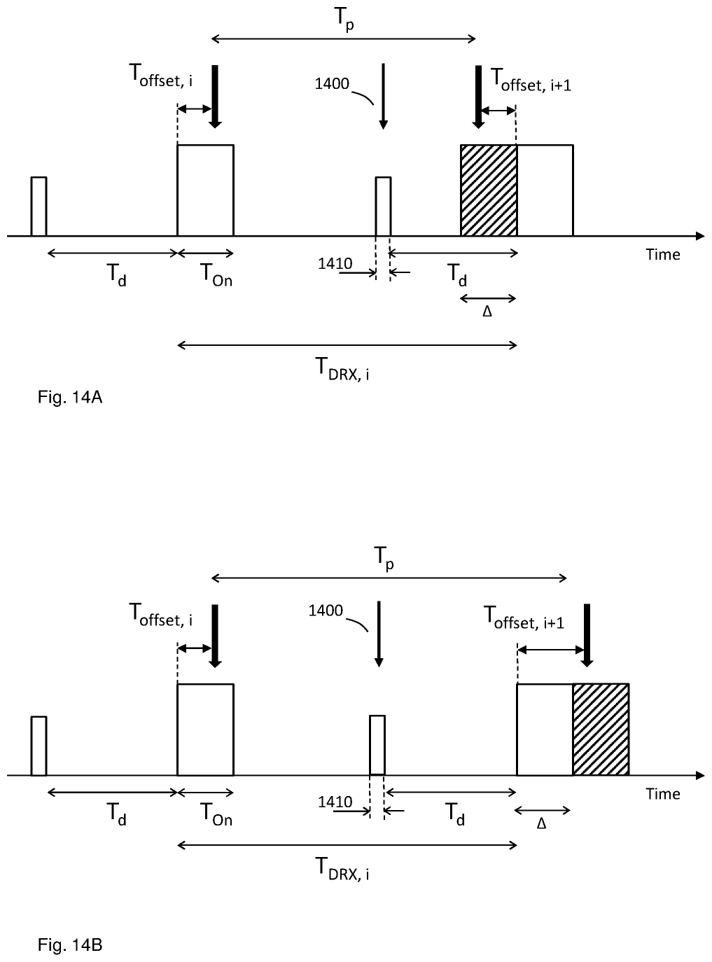

FIGS. 14A and 14B schematically illustrates the timing adjustment applied based on information obtained in the EIS 1400. The UE 10 is configured to listen to the channel, such as PDCCH, for the EIS 1400, within a monitoring window 1410, configured at a time distance Ta ms in advance of the intended configured DRX ON duration. The EIS notifies the UE 10 whether to adjust the upcoming, next, ON duration based on misalignment with expected packet arrival time. The EIS 1400 may further identify how the UE 10 shall adjust timing. For the purpose of preparing the information PAR to be transmitted in the EIS 1400, the access node 121 gNB calculates in advance and evaluates whether the start of the next ON duration, i.e. the ON duration of the next DRX cycle, needs to be advanced, stay without change, or be delayed. This determination of the information PAR corresponds to step 520 of FIG. 5.

In FIGS. 14A and 14B, the EIS 1400 is indicated as received in the monitoring window 1410 configured for EIS transmission at a time distance Ta before the next ON duration. In this context, reception of the EIS 1400 correlates with step 540 of FIG. 5 and step 630 of FIG. 6. The calculation and evaluation are made taking into account both the non-integer arrival of the packets and potential jitter affecting the configured DRX parameters. Whenever the expected packet arrival from the access node 121 to the UE 10 is outside the ON duration, and depending on whether the packet arrives before the start of the ON duration or after the end of the ON duration, the start of ON duration is advanced or delayed, respectively, by a certain period, adjustment time Δ.

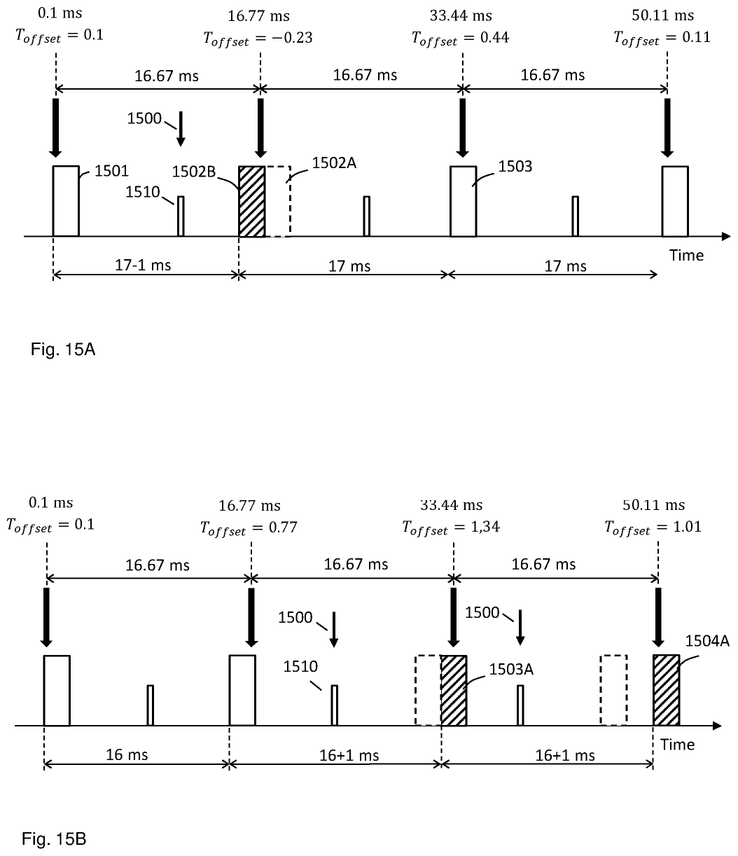

FIGS. 15A and 15B show embodiments corresponding to those of FIGS. 9A and 9B, and illustrate examples of advancing and delaying the start of ON duration, respectively, for data traffic with 60 frame per second (fps) resulting in a periodicity Tₚ for packet arrival time of 16.67 ms. In correspondence with FIG. 4, the downwards-pointing arrows indicate expected packet arrival time based on the periodicity Tₚ. White ON duration boxes indicate the configured DRX ON durations, e.g. according to short C-DRX, whereas the patterned boxes indicate ON durations according to the adjusted timing. The left edge of the respective box marks the intended starting point of the respective ON duration. ON duration is configured to 1 ms. The monitoring window 1510 configured for the EIS 1500 is indicated prior to each ON duration, within which the EIS 1500 is received.

In the example of FIG. 15A, the DRX length is set to 17 ms, which is the closest integer ms DRX cycle with respect to the periodicity Tₚ. In an embodiment where the DRX cycle is determined based on the traffic information, the DRX length/cycle is set to an integer value 17 ms, calculated by rounding up the non-integer packet arrival interval of the data traffic, e.g. an XR type, to its nearest integer value. In the shown example, expected packet arrival time is at an offset of 0.1 ms after start of the first shown ON duration 1501. Consequently, the next (second) packet arrival time will be earlier than the intended starting point of the next ON duration 1502A. For this reason, and following the described example as provided in FIG. 8, adjusted timing will be applied to the next ON duration to advance the starting time by an adjustment time Δ, such that the adjusted next ON duration 1502B starts 1 ms earlier. Information PAR identifying the timing adjustment is transmitted from the access node 121 in the EIS 1500 within the configured monitoring window 1510 which precedes the ON duration 1502A which is to be adjusted. The subsequent ON duration 1503, following the adjusted second ON duration 1502B will have an intended starting point at 17 ms from the adjusted starting point of ON duration 1502B. Since that ON duration 1503 is aligned with the expected packet arrival time, no EIS is transmitted in the preceding monitoring window.

In the example of FIG. 15B, The DRX cycle length is configured to 16 ms. In an embodiment where the DRX cycle is determined based on the traffic information, the DRX length/cycle is set to an integer value 16 ms, calculated by rounding down the non-integer packet arrival interval of the data traffic, e.g. an XR type, to its nearest integer value. The proposed solution according to this example will cause adjustment of the starting time of the 3rd 1503A and 4th 1504A ON durations to match with arrival of the data packets. Information PAR identifying the timing adjustment is transmitted from the access node 121 in the EIS 1500 within the configured monitoring window 1510 which precedes the respective ON duration which is to be adjusted.

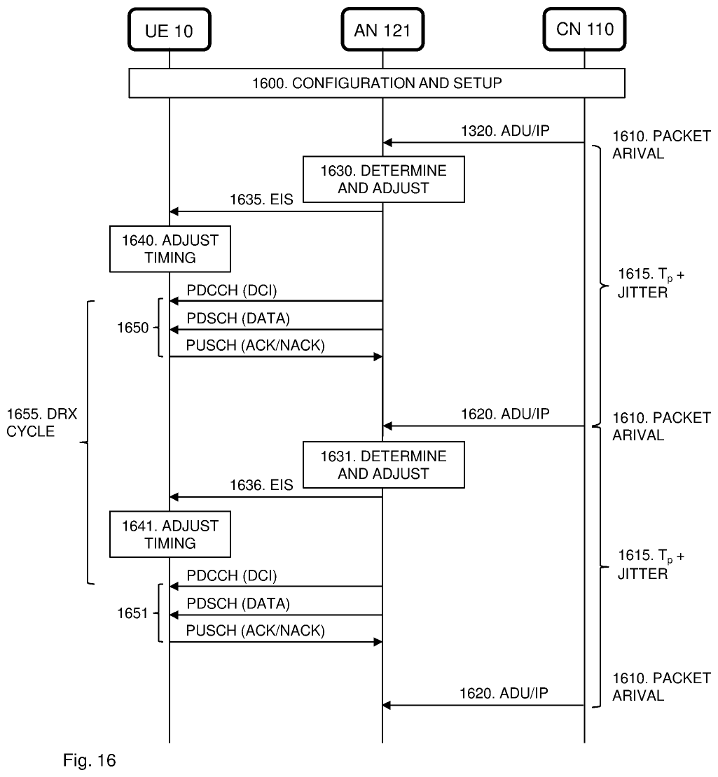

FIG. 16 shows a signaling diagram of an embodiment of the proposed solution, wherein explicit configuration of the UE 10 is made by the access node by transmitting information identifying timing adjustment in an early indication signal, EIS.

A stage 1600 of configuration and setup is initially provided. According to some embodiments, a capability of the UE 10, and possibly also of the access node 121, in an initialization phase of stage 1600. This may include the access node 121 and the UE 10 declaring whether or not they support adaptation of DRX configuration to advance/delay/extend according to the proposed solution. Such a declaration of capability may be a prerequisite to proceed in accordance with this signaling diagram.

The configuration and setup stage 1600 comprises steps required for configuring the UE 10 with a connected mode DRX configuration for use in at least DL communication of data traffic related to a service or an application, such as an XR application. This correlates to step 510 of FIG. 5 and step 610 of FIG. 6. This may be accomplished according to legacy procedures. In stage 1600, the access node 121 obtains information on adjusted timing to apply to the DRX configuration, based on traffic information. This information may comprise a scheme to apply for adapting the DRX configuration, such as to apply adjusted timing for ON durations of the DRX configuration. As noted, the access node 121 may be configured to determine the adjusted timing based on traffic awareness, wherein the traffic information may comprise an indication of the service or application. Alternatively, the traffic information may identify a scheme to apply for determining the adjusted timing. The traffic information may e.g. be received by the access node 121 from the core network 110.

The configuration and setup stage 1600 may further configure the UE 10 to receive information for applying timing adjustment to adapt the DRX on a per ON duration basis, according to the proposed solution. This involves identifying a monitoring window 140, 1510 for the EIS.

In some embodiments, the configuration and setup stage 1600 further comprises identifying a level of jitter in the wireless network 100, and informing the UE 10. This configuration and setup stage may further include transmitting an indication of the scheme to apply, for example as exemplified with reference to FIGS. 8-11. In some embodiments, this may include transmitting, from the access node 121 to the UE 10, parameters for the timing adjustment, such as the adjustment time Δ, and possibly an identified starting point for an ON duration of the DRX configuration, such as a system frame number (SFN) number, e.g. pointing to the first sub-frame/slot and first OFDM symbol of that SFN.

Upon running the service or application, which provides data traffic with an expected packet arrival time determined by e.g. a frame rate, packet arrival 1610 to the network 100 will occur with a certain periodicity Tₚ 1615 associated with the frame rate. The packet arrival time may further be affected by jitter. The data packets will be conveyed 1620 from the core network 110 to the access node 121 in e.g. application data units (ADU) or IP packets, in accordance with the packet arrival time.

In step 1630 the access node 121 determines the need to adjust timing, to handle misalignment between packet arrival and the DRX configuration and/or jitter. The scheme to use for determining the adjusted timing may have been obtained in stage 1600, e.g. from the core network, or be determined by the access node 121 based on the traffic information, as described. In some embodiments, traffic information associated with the service or application explicitly or implicitly determines the DRX configuration and/or identifies parameters for use in the timing adjustment 1630. The adjusted timing determined in step 1630 correlates with step 520 of FIG. 5. If jitter is experienced, this is also handled by the access node 121. Where the determined timing adjustment implies a delay or advancement of ON duration starting point, this will apply to the next ON duration.

In step 1635, the access node 121 transmits an EIS in the configured monitoring window responsive to determining in step 1630 that timing adjustment is to be carried out. This correlates with step 540 of FIG. 5. The EIS is received by the UE 10, and based on the information PAR comprised in the EIS, the UE 10 adjusts 1640 timing for the upcoming, next, ON duration. This correlates with step 630 of FIG. 6.

In step 1650, the UE 10 monitors the ON duration according to the DRX configuration, possibly adapted based on a received timing adjustment indicated by the information PAR received 1635 in the EIS. In the next ON duration, the UE 10 communicates with the access node 121. This may include, according to legacy procedures, receiving DCI on a physical downlink control channel (PDCCH), receiving the data in a physical downlink shared channel (PDSCH), and providing acknowledgement on a physical uplink shared channel (PUSCH). Based on the information PAR, the UE 10 is thus configured to apply 1640 adjusted timing to the next ON duration monitored in step 1650, which may imply either delaying or advancing the starting point of that next ON duration. The UE 10 will receive data, transmitted by the access node 121 which may be adapted according to the received information PAR identifying the timing adjustment. This corresponds to step 550 of FIG. 5 and step 640 of FIG. 6.

This process is subsequently repeated for each DRX cycle 1655 in which packet arrival occurs and the UE operates based on the configured DRX operation. As starting time of the ON durations are adjusted, also the actual DRX cycle 1655 may be adjusted where the preceding ON duration has been delayed or advanced according to the proposed solution. In this case, the actual ON duration has been adjusted (delayed or advanced) from the configured ON duration. The reference time for DRX cycle 1655 could refer to the configured starting ON duration or the adjusted ON duration.

By means of explicit DL transmission 540, 630 of information PAR identifying timing adjustment, the UE 10 is configured to re-adjust its DRX parameters temporarily with limited processing required by the UE 10.

In various embodiments corresponding to what has been described with reference to FIGS. 14-16, the EIS is used for carrying information PAR which identifies the timing adjustment. The purpose is to notify the UE 10 whether to re-arrange the start of the ON duration and, where applicable, how and for how long. In one embodiment, the information PAR comprises at least one or the combinations of the following information, which is transmitted in the EIS:

PAR_0: Wake-up indication or a go-to-sleep indication. This indicator may be read in the UE 10 and used to determine whether the UE 10 needs to activate during the scheduled ON period. This may be conveyed by 1 bit. If PAR_0 provides a go-to-sleep indication, no further indicators of PAR need to be read by the UE 10.

PAR_1: Re-arrangement indication. This indicator may be read in the UE 10 and used to determine whether or not timing adjustment of the starting time of the next ON duration shall be made. This may be conveyed by 1 bit. If PAR_1 indicates that no timing adjustment shall be made, no further indicators of PAR need to be read by the UE 10.

PAR_2: Adjustment direction. This indicator may be read in the UE 10 and used to determine whether advance or delay of the starting time of the next ON duration shall be made. This may be conveyed by 1 bit.

PAR_3: A value on how long to delay or advance-L bit, dependent on the precision of the number to be indicated. Each bit can represent a time unit, which may be configured in the configuration stage 1600 and informed to the UE 10. For example, 1 bit may represent a time slot or N time slots. It may also depend on the operated subcarrier spacing (SCS).

In some embodiments, the EIS can include information for more than one UE. This means that the total size of the EIS can extend to carry the above information PAR in the form of information block for up to N UEs.

In some embodiments, the EIS can be scrambled with a new RNTI (Radio Network Temporary Identifier) for the UE 10. The access node 121 may assign the new RNTI to the UE 10, or the new RNTI may be defined in specification, similar to P-RNTI. Where the UE 10 intends to monitor EIS, it may use that RNTI in order to descramble/decode the EIS.

As noted, the EIS is transmitted outside the DRX ON duration, within a monitoring window configured at a time distance larger than T_{d} ms prior to the starting time of the upcoming ON duration. This time distance needs to be long enough to accommodate both for the maximum possible jitter experienced and the maximum possible time offset between the expected arrival time and the start of DRX ON. This way it is ensured that the UE 10 securely receives the information PAR needed for timing adjustment of the ON duration. This means that

T_{jitter,max}+T_{offset,max}<T_{d}<T_{DRX}.

The monitoring window 140, 1510 for the EIS is configured based on the above. This may be done explicitly by the access node 121, or be based on traffic information, such as dependent on DRX configuration or dependent on a service or application type for which the data traffic will be transmitted.

In the foregoing, general solutions and more detailed examples have been outlined, with reference to the drawings. Unless clearly contradictory, the features of any example provided herein may be combined in any way, including any combination of the features of the claims set out below.

1. Method carried out in an access node of a wireless network for managing configuration of discontinuous reception (DRX) for a user equipment (UE), said DRX configuration comprising ON durations repeated with a DRX cycle, wherein the method comprises:
obtaining adjusted timing for a next ON duration, based on traffic information of data for the UE;
transmitting, to the UE, information identifying the adjusted timing; and
transmitting the data to the UE in the next ON duration according to the adjusted timing.

2. The method of claim 1, wherein the traffic information is indicative of expected packet arrival time of the data.

3. The method of claim 2, wherein the adjusted timing is configured to accommodate for misalignment of the expected arrival time and the DRX configuration.

4. The method of claim 1, wherein the adjusted timing identifies a starting point of the next ON duration which is offset by an adjustment time (A) from an intended starting point according to the DRX configuration.

5. The method of claim 1, wherein the adjusted timing identifies:
an extension of monitoring time of the next ON duration, responsive to expected packet arrival time occurring within a preconfigured period later than an intended starting point of the next ON duration according to the DRX configuration, or
a starting point of the next ON duration which is offset by an adjustment time (A) from an intended starting point according to the DRX configuration.

6. The method of claim 4, wherein the adjustment time comprises a difference between the expected packet arrival time and the intended starting point of the next ON duration.

7. The method of claim 1, wherein said information is transmitted in the ON duration preceding the next ON duration.

8. The method of claim 5, wherein said adjusted timing identifies the extension of monitoring time, wherein said information is transmitted within an unadjusted time frame of the next ON duration.

9. The method of claim 1, wherein said information is transmitted in an early indication signal, configured between the ON durations of the DRX cycle.

10. The method of claim 9, wherein the early indication signal is transmitted in a downlink control channel.

11. The method of claim 10, wherein the early indication signal is scrambled with a temporary identifier.

12. The method of claim 11, wherein the temporary identifier is assigned to the UE by the access node.

13. The method of claim 11, wherein the temporary identifier is a predefined.

14. The method of claim 9,
configuring the UE with a monitoring window for the early indication signal, at a configured time distance in advance of each ON duration.

15. The method of claim 14, wherein said time distance is configured to exceed a maximum possible offset between expected packet arrival time and a starting point of the ON duration following the early indication signal.

16. The method of claim 15, comprising:
measuring jitter on a communication link for receiving the data, wherein said time distance further comprises a component accounting for the measured jitter.

17. The method of claim 9, wherein the information identifies whether or not data is transmitted to the UE in the ON duration following the early indication signal.

18. The method of claim 9, wherein the information comprises a first adjustment indicator identifying whether adjustment of the ON duration following the early indication signal is made.

19. The method of claim 18, wherein the information comprises a second adjustment indicator identifying whether a delay or advance adjustment is made.

20-30. (canceled)

31. Method carried out in a user equipment (UE), for managing discontinuous reception (DRX) configuration, said DRX configuration comprising ON durations repeated with a DRX cycle, wherein the method comprises:
receiving, based on misalignment of expected arrival time of data for the UE and an intended next ON duration, information from an access node, wherein said information identifies adjusted timing for a next ON duration; and
receiving the data the next ON duration according to the adjusted timing.

32-49. (canceled)
